(19) United States
(12) Patent Application Publication
(10) Pub. No.: US 2020/0143292 A1
(43) Pub. Date: May 7, 2020

(54) SIGNATURE ENHANCEMENT FOR DEVIATION MEASUREMENT-BASED CLASSIFICATION OF A DETECTED ANOMALY IN AN INDUSTRIAL ASSET

(71) Applicant: General Electric Company, Schenectady, NY (US)

(72) Inventor: Hao HUANG, San Ramon, CA (US)

(21) Appl. No.: 16/177,633

(22) Filed: Nov. 1, 2018

(51) Int. Cl. G06N 99/00; G05B 23/02

(52) U.S. Cl. CPC G06N 99/005; G05B 23/0243

(57) ABSTRACT

A method of deviation measurement-based classification of an anomaly detected in an industrial asset includes accessing sensor data readings obtained at a monitored industrial asset, performing a temporal feature transformation technique on the accessed sensor data readings to create a set of transformed features for the accessed sensor data readings, calculating normalized features for the set of transformed features and corresponding accessed sensor data reading, constructing an anomaly model for the monitored industrial asset, the anomaly model selected from a group of possible anomaly models, each possible anomaly model based on a different training data set, training the anomaly model, testing the trained anomaly model, performing a sliding window feature extraction on the trained anomaly model, classifying the extracted features, and providing the feature classification to a user. A system and a non-transitory computer-readable medium are also disclosed.

### BACKGROUND

Effective data-driven analytics is possible using advancements in sensor technologies and networked industrial machinery design. Industrial assets often have multiple sensors monitoring operation. With connection to the Internet of Things (IoT), access to the sensor data can be obtained in data streams at almost real time. This increasing availability of streaming time series data can have a practical purpose in detecting anomalies in the operation of the industrial asset.

An industrial asset can be, among other things and without limitation, a generator, gas turbine, power plant, manufacturing equipment on a production line, aircraft engine, wind turbine generator, locomotive, imaging device (e.g., X-ray, MRI, CT, PET, SPECT systems), or mining operation drilling equipment. Each instance of a time series data set is recorded at a certain timestamp of an asset. An event is a failure case that happens at a certain timestamp within the time series data.

An anomaly in the time series data can indicate a change in the industrial asset's status (e.g., a change in turbine rotation). Identification of the anomaly can be beneficial in predicting faults and/or updating maintenance schedules.

Conventional data-driven analysis is failing to answer modern challenges in machine failure detection classification. For example, each industrial asset machine has a unique signal pattern that differs from other industrial asset machines, even if the machines are of the same domain (e.g., model) and located in the same operating environment. These unique signal patterns can result from its own response to its operating environment (due to, for example, component tolerances, manual operator control, and maintenance performance, wear and tear, and other factors).

Because of these differences between industrial asset machine signal patterns, conventional approaches are not well suited to classify anomalies across a fleet of industrial assets.

### BRIEF DESCRIPTION OF THE DRAWINGS

FIG. 1 illustrates a process that implements an anomaly signature classification algorithm in accordance with embodiments; and

FIG. 2 illustrates a system for implementing the anomaly signature classification algorithm of FIG. 1 in accordance with embodiments.

### DESCRIPTION

Embodying systems and methods provide enhance failure signature recognition among a fleet of industrial assets (i.e., different units of the same model) by measuring the degree of deviation of each machine's own context. This deviation of machine context can result in unique signal patterns for each unit. Similarly situated units can still have contextual deviation due to unique factors such as component tolerances, calibration drift, usage, etc.

Embodying systems and methods can enhance the identification and classification of failure signatures among industrial assets of the same domain operating under the same or different industrial backgrounds. In accordance with embodiments, failure signature enhancement is achieved by measuring the degree of deviation of each machine's own context through two types of deviation measurements:

(1) Asset level normalized measurement based on a basis time period; and

(2) Short term and long term anomaly degree measurement.

An embodying anomaly signature classification algorithm can apply both short and long term anomaly measurement for failure signature enhancement. In accordance with embodiments, the algorithm can apply two levels of sliding windows as temporal feature engineering. Features having different data statistics/perspectives can be extracted from the two sliding windows. A user can be provided the freedom to select different anomaly detection and classification options to analyze the extracted data.

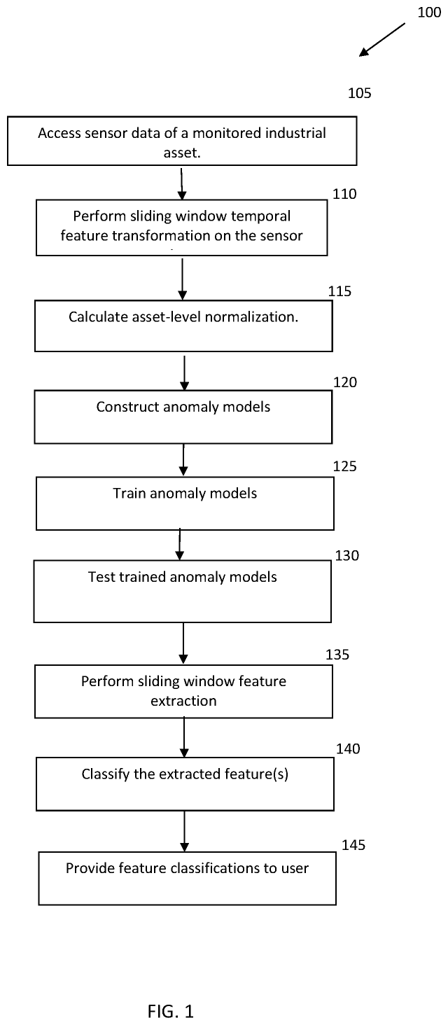

FIG. 1 illustrates process 100 to implement an anomaly signature classification (ASC) algorithm in accordance with embodiments. The embodying ASC algorithm can include accessing sensor data of one or more industrial assets, step 105. The sensor data can be recorded by sensors distributed within the industrial asset that are monitoring parameters of the industrial asset's operation (e.g., (as applicable) temperature, fluid pressure, voltage, revolution per minute, etc.). This recorded sensor data can be provided to a remote data store.

The ASC algorithm can perform temporal feature transformation on the sensor data, step 110. In accordance with embodiments, temporal feature transformation can be calculated with a sliding-window of a certain length l. The ASC algorithm can include two types of feature transformation: univariate and pair-wise. The feature transformation can have as input a vector b related to one/two raw features, with length(b)=l. The output is one scalar.

Given a time-series vector b ∈ R^{l×1}, univariate feature transformation options can include, but are not limited to: moving-average (mean(b)); standard deviation (std(b)); level-shift (lsf(b)=max(b)−min(b)); autocorrelation (autocorr(b)); standard deviation of delta sdn(b)=std(diff(b))); vibration degree (vbr(b)=std(b)×sdn(b)); spike

$$( spk ( b ) = {b}_{l / 2} - mean ( {b}_{1 : \frac{l}{3}} , {b}_{\frac{2 l}{3} : l} ) ) .$$

Given a two dimensional time-series vector b ∈ R^{l×2}, pair-wise feature transformation options can include, but are not limited to: covariance (cov(b)=covariance(b_{:,1},b_{:,2})); and correlation (crl(b)=correlation(b_{:,1},b_{:,2})).

In accordance with embodiments, a user can select which type (univariate or pair-wise) of feature transformation to perform on the sensor data (input parameter set P). Also, user selection can include which feature option transformation is to be applied to the input parameter set P. In accordance with embodiments, feature transformation can be performed on the whole, or a partial portion of input parameter set P. The transformed features are denoted below as tran-P, which is different from the raw input data set P (denoted raw-P).

Asset-level normalization (deviation measurement) can be performed, step 115, by calculating normalized features for raw-P and tran-P. In some implementations, the normalization calculation can be based on a predefined time period for each set of sensor data from different industrial assets. For example, one default option can be to use the first year of the industrial asset's operation as basis to determine that particular asset's mean and standard-deviation. Then a standardized value can be calculated for the sensor data after the first year of that asset's operation. The normalized features are denoted below as norm-P.

In accordance with embodiments, to measure (quantify) the anomaly degree for both short-term and long-term measurements, anomaly models can be constructed, step 120. For each particular industrial asset unit, three types of anomaly models can be built. Each of these anomaly model types can be based on a different training set. Here only tran-P is used for modeling.

The anomaly model is trained, step 125. The different training sets for the anomaly model can include a basis model, a short-term model, and a long-term model. The basis model is trained on a predefined basis time period of each asset. For example, a basis time period can be defined as the first year of asset operation. The short-term model is trained on a selected time window, which can be a recent time window for the asset operation. For example, only the latest four months of data can be selected as the basis time period. The long-term model can be a trained on sensor data that includes the entire asset operation history.

In accordance with embodiments, four options to train the three types of anomaly models can include, but are not limited to the following options: a manifold learning model; a one-class support vector machine (SVM) model; a gaussian mixture model; and an isolation forest model.

In accordance with embodiments, the manifold learning model can implement a multi-kernel-based projection algorithm that constructs a similarity matrix from the training and testing data sets. A projection matrix is then calculated for each element of the similarity matrix. Projected embeddings are then calculated for the elements of the projection matrix. The projected embeddings are used to calculate anomaly score matrix elements, from which an overall anomaly score can be computed.

The trained anomaly models are then tested, step 130, on each selected batch of sensor data. To test the models, the batch of sensor data needs a certain number of samples or certain time period; for example, three days can be a default value. The average (avg) and maximum (max) anomaly score of the batch is retained. For each selected batch of asset sensor data, the following short term and long term anomaly degree measurements are retained: basis_anomaly_avg; basis_anomaly_max; short_anomaly_avg; short_anomaly_max; long_anomaly_avg; and long_anomaly_max. These anomaly features are denoted as anomaly-P.

A (second) sliding window feature extraction is performed, step 135. In accordance with embodiments, statistics extraction on tran-P and norm-P are done with a default sliding-window time period (e.g., for example three). The input is vector b related to one features in tran-P or norm-P. The output is one scalar, for example, standard deviation (std(b)); level-shift (lsf(b)=max(b)−min(b)); minimum (min(b)); mean (mean(b)); and maximum (max(b)). The feature generated by the second level extraction is denoted as scn-level-P.

The extracted features are classified, step 140. The feature space of the dataset includes scn-level-P and anomaly-P. The samples are labeled as normal or event-relevant by a predefined time window. For example, a sample will be labeled as event-relevant if it is within, for example, two months ahead of any event; and normal if it is not, or if it is from some asset that never has any event. In accordance with embodiments, classification modeling techniques are then applied on the dataset and labels.

The anomaly signature feature classifications are provided, step 145, to a user. The classifications can be presented on a display, communicated electronically in a file, and/or by any data presentation mechanism.

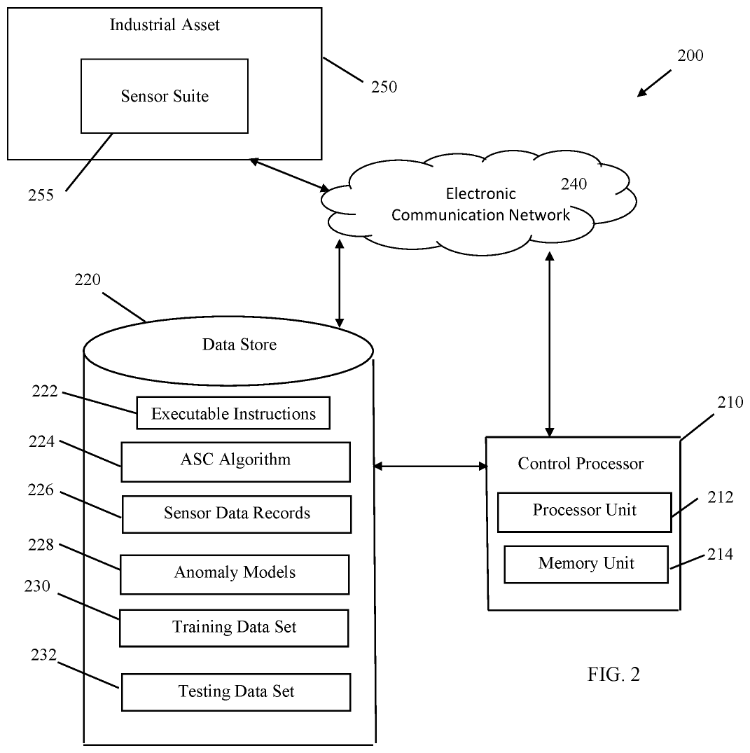

FIG. 2 illustrates system 200 for implementing ASC algorithm 100 in accordance with embodiments. Control processor 210 can include processor unit 212 and memory unit 214. The control processor can be in direct communication with data store 220, or in indirect communication across electronic communication network 240. Processor unit 212 can execute executable instructions 222, which cause the processor to perform ASC algorithm 100 in accordance with embodiments. Memory unit 214 can provide the control processor with local cache memory.

The data store can include sensor data records 226 that contain operational data monitored by sensor suite 255 in industrial asset 250. Only one industrial asset is depicted, however, there can be multiple industrial assets each including sensor suites that provide monitored data across electronic communication network 240 to data store 220. The data store can also include ASC algorithm 224, anomaly models 228, training data set 230, and testing data set 232.

In accordance with some embodiments, a computer program application stored in non-volatile memory or computer-readable medium (e.g., register memory, processor cache, RAM, ROM, hard drive, flash memory, CD ROM, magnetic media, etc.) may include code or executable program instructions that when executed may instruct and/or cause a controller or processor to perform methods discussed herein such as a method of deviation measurement-based classification of detected anomalies in an industrial asset, as disclosed above.

The computer-readable medium may be a non-transitory computer-readable media including all forms and types of memory and all computer-readable media except for a transitory, propagating signal. In one implementation, the non-volatile memory or computer-readable medium may be external memory.

Although specific hardware and methods have been described herein, note that any number of other configurations may be provided in accordance with embodiments of the invention. Thus, while there have been shown, described, and pointed out fundamental novel features of the invention, it will be understood that various omissions, substitutions, and changes in the form and details of the illustrated embodiments, and in their operation, may be made by those skilled in the art without departing from the spirit and scope of the invention. Substitutions of elements from one embodiment to another are also fully intended and contemplated. The invention is defined solely with regard to the claims appended hereto, and equivalents of the recitations therein.

1. A method of classifying an anomaly detected in an industrial asset, the method comprising:
accessing sensor data readings obtained at a monitored industrial asset;
performing a temporal feature transformation technique on the accessed sensor data readings to create a set of transformed features for the accessed sensor data readings;
calculating normalized features for the set of transformed features and corresponding accessed sensor data reading;
constructing an anomaly model for the monitored industrial asset, the anomaly model selected from a group of possible anomaly models, each possible anomaly model based on a different training data set;
training the anomaly model;
testing the trained anomaly model;
performing a sliding window feature extraction on the trained anomaly model;
classifying the extracted features; and
providing the feature classification to a user.

2. The method of claim 1, the temporal feature transformation including:
receiving from a user a selection of a univariate transformation technique or a pair-wise transformation technique; and
applying a sliding window time frame during the selected transformation technique.

3. The method of claim 1, including performing the temporal feature transformation on an entirety of the accessed sensor data readings or on a portion of the accessed sensor data readings.

4. The method of claim 1, including calculating the normalized features for a predefined time period.

5. The method of claim 1, the group of possible anomaly models including a basis model trained on a predefined basis time period, a short-term model trained on a selected time window, and a long-term model trained on an entirety of the accessed sensor data readings for a particular industrial asset.

6. The method of claim 1, the anomaly model training including selecting a training technique from a manifold learning model, a one-class support vector machine model, a gaussian mixture mode, and an isolation forest model.

7. A non-transitory computer-readable medium having stored thereon instructions which when executed by a control processor cause the control processor to perform a method of classifying an anomaly detected in an industrial asset, the method comprising:
accessing sensor data readings obtained at a monitored industrial asset;
performing a temporal feature transformation technique on the accessed sensor data readings to create a set of transformed features for the accessed sensor data readings;
calculating normalized features for the set of transformed features and corresponding accessed sensor data reading;
constructing an anomaly model for the monitored industrial asset, the anomaly model selected from a group of possible anomaly models, each possible anomaly model based on a different training data set;
training the anomaly model;
testing the trained anomaly model;
performing a sliding window feature extraction on the trained anomaly model;
classifying the extracted features; and
providing the feature classification to a user.

8. The non-transitory computer-readable medium of claim 7, the instructions further configured to cause the control processor to perform the temporal feature transformation by:
receiving from a user a selection of a univariate transformation technique or a pair-wise transformation technique; and
applying a sliding window time frame during the selected transformation technique.

9. The non-transitory computer-readable medium of claim 7, the instructions further configured to cause the control processor to perform the temporal feature transformation on an entirety of the accessed sensor data readings or on a portion of the accessed sensor data readings.

10. The non-transitory computer-readable medium of claim 7, the instructions further configured to cause the control processor to perform calculating the normalized features for a predefined time period.

11. The non-transitory computer-readable medium of claim 7, the instructions further configured to cause the control processor to perform the anomaly model training by selecting a training technique from a manifold learning model, a one-class support vector machine model, a gaussian mixture mode, and an isolation forest model.

12. A system for classifying an anomaly detected in an industrial asset, the system comprising:
a control processor in communication with a data store across an electronic communication network, the control processor including a processor unit;
the data store including executable instructions and sensor data records representing monitored conditions of one or more components of an industrial asset;
the executable instructions when executed by the processor unit cause the processor unit to perform a method, the method comprising:
accessing sensor data readings obtained at a monitored industrial asset;
performing a temporal feature transformation technique on the accessed sensor data readings to create a set of transformed features for the accessed sensor data readings;
calculating normalized features for the set of transformed features and corresponding accessed sensor data reading;
constructing an anomaly model for the monitored industrial asset, the anomaly model selected from a group of possible anomaly models, each possible anomaly model based on a different training data set;
training the anomaly model;
testing the trained anomaly model;
performing a sliding window feature extraction on the trained anomaly model;
classifying the extracted features; and
providing the feature classification to a user.

13. The system of claim 12, the executable instructions further configured to cause the processor unit to perform the temporal feature transformation by:
receiving from a user a selection of a univariate transformation technique or a pair-wise transformation technique; and
applying a sliding window time frame during the selected transformation technique.

14. The system of claim 12, the executable instructions further configured to cause the processor unit to cause the control processor to perform the temporal feature transformation on an entirety of the accessed sensor data readings or on a portion of the accessed sensor data readings.

15. The system of claim 12, the executable instructions further configured to cause the processor unit to cause the control processor to perform calculating the normalized features for a predefined time period.

16. The system of claim 12, the executable instructions further configured to cause the processor unit to cause the control processor to perform the anomaly model training by selecting a training technique from a manifold learning model, a one-class support vector machine model, a gaussian mixture mode, and an isolation forest model.
